(19) United States
(12) Patent Application Publication
(10) Pub. No.: US 2026/0322782 A1
(43) Pub. Date: Oct. 15, 2026

(54) Routing Device For Accessing Network Device By Terminal Device, And Network Connection Method

(71) Applicant: Siemens Aktiengesellschaft, München (DE)

(72) Inventors: Ling Tian Zhu, Nanjing (CN); Zheng Ping Lin, Nanjing (CN); Min Zhou, Beijing (CN)

(73) Assignee: Siemens Aktiengesellschaft, München (DE)

(21) Appl. No.: 19/116,619

(22) PCT Filed: Sep. 30, 2022
(86) PCT No.: PCT/CN2022/123537

§ 371 Date: Mar. 28, 2025

(51) Int. Cl. H04L 61/5014

(52) U.S. Cl. CPC H04L 61/5014

(57) ABSTRACT

A routing device for accessing a network device by a terminal device may include a first communication module, a processing module, and a second communication module. The processing module sends a first probe packet. The first communication module sends the first probe packet to the network device and sends the first response packet generated by the network device to the processing module. The processing module modifies an IP address of the routing device based on the first response packet such that the IP addresses of the routing device and the network device are in a shared network segment. The second communication module is connected to the processing module and the terminal device. The processing module assigns an IP address in the same network segment as that of the routing device to the terminal device.

### CROSS-REFERENCE TO RELATED APPLICATIONS

This application is a U.S. National Stage Application of International Application No. PCT/CN2022/123537 filed Sep. 30, 2022, which designates the United States of America, the contents of which are hereby incorporated by reference in their entirety.

### TECHNICAL FIELD

The present disclosure relates to routing devices. Various embodiments of the teachings herein include routing devices for accessing a network device by a terminal device, and network connection methods using the routing devices.

### BACKGROUND

A network device has an internal web server and is accessible via a browser of a terminal device, such as a laptop computer, a mobile phone, or a tablet computer. For accessing the network device, over a wireless network, the web server of the network device with a fixed Internet Protocol (IP) address, the terminal device is connected to the network device with an RJ45connector using a wireless router via a network cable. As a prerequisite, a user needs to manually configure the network device or the wireless router (as required by Transmission Control Protocol/Internet Protocol, TCP/IP) to ensure that the terminal device is capable of accessing the web server of the network via Wi-Fi. During manual configuration, the user needs to first acquire the IP address of the network device using some designated tools that fail to be used by the user or hard to be operated by the user, and adjust an IP address of the wireless router to be in the same network segment as the IP address of the network device. If the IP addresses are not in the same network segment, the terminal device may fail to access the network device due to restrictions of TCP/IP. This causes some inconveniences to common users in accessing the network device.

### SUMMARY

Teachings of the present disclosure include routing devices for accessing a network device by a terminal device. The routing devices are capable of automatically configuring network parameters, such that it is convenient for a user to establish a wireless connection between the terminal device and the network device. Some embodiments include a network connection method using one of the routing devices. For example, some embodiments include a routing device for accessing a network device by a terminal device, comprising: a first communication module (10), configured to be communicably connected to the network device (80) ; a processing module (20), communicably connected to the first communication module (10), wherein the processing module (20) is capable of sending a first probe packet to the first communication module (10), the first communication module (10) is capable of sending the first probe packet to the network device to acquire an IP address of the network device, the network device is capable of generating a first response packet based on the first probe packet and sending the first response packet to the first communication module, the first communication module (10) is capable of sending the first response packet to the processing module (20), and the processing module (20) is capable of modifying an IP address of the routing device based on the first response packet such that the IP address of the routing device and the IP address of the network device (80) are in a same network segment, the first response packet comprising an IP address of the network device; and a second communication module (30), communicably connected to the processing module (20) and configured to be communicably connected to the terminal device (90), wherein the processing module (20) is capable of assigning an IP address in the same network segment as the IP address of the routing device to the terminal device (90) via the second communication module (30).

In some embodiments, the network device (80) comprises a first web server (81), and the processing module (20) separately defines domain names of the network device and the routing device and then separately sends out a correspondence between the IP address and domain name of the network device and a correspondence between the IP address and domain name of the routing device in a form of signal; the terminal device (90) is capable of parsing out the IP address of the web server to be accessed based on the domain name data of the web server to be accessed according to the received correspondences between the IP addresses and the domain names, generating a webpage access request packet including the parsed IP address of the web server to be accessed, and sending the webpage access request packet to the processing module (20) via the second communication module (30), and the processing module (20) is capable of determining whether the IP address of the web server to be accessed is the IP address of the network device (80) or the routing device based on the IP address of the web server to be accessed included in the webpage access request packet; in response to determining that the parsed out IP address is the IP address of the network device (80), the processing module (20) is capable of forwarding the webpage access request packet to the first web server (81) via the first communication module (10); the first web server (81) is capable of generating a second response packet by parsing the webpage access request packet, and sending the second response packet to the processing module (20) via the first communication module (10); and the processing module (20) is capable of sending the second response packet to the terminal device (90) via the second communication module (30).

In some embodiments, the routing device further comprises: a second web server (40), wherein the second web server (40) is configured to manage the routing device; the processing module (20) separately defines domain names of the network device (80) and the routing device and then separately sends out a correspondence between the IP address and domain name of the network device (80) and a correspondence between the IP address and domain name of the routing device in a form of signal; the terminal device (90) is capable of generating a webpage access request packet including an IP address of the web server to be accessed based on the domain name data of the web server to be accessed according to the received correspondences between the IP addresses and the domain names, and sending the webpage access request packet to the processing module via the second communication module (30); the processing module is capable of determining whether the IP address of the web server to be accessed is the IP address of the network device (80) or the routing device based on the IP address of the web server to be accessed included in the webpage access request packet; in response to determining that the parsed out IP address is the IP address of the routing device, the processing module is capable of forwarding the webpage access request packet to the second web server (81) ; and the second web server (81) is capable of generating a third response packet by parsing the webpage access request packet, and sending the third response packet to the terminal device (90) via the second communication module (20).

In some embodiments, the first probe packet and the first response packet are DCP packets.

In some embodiments, the processing module (20) is capable of assigning, using DHCP, the IP address in the same network segment as the IP address of the routing device to the terminal device (90), the first communication module (10) is capable of sending the first response packet to the processing module (20) via an MAC layer, and the webpage access request packet and the second response packet are transmitted via the MAC layer.

In some embodiments, the third response packet is transmitted via a TCP layer.

In some embodiments, the first communication module (10) is capable of being connected to the network device (80) via wired communication, and the second communication module (30) is capable of being connected to the terminal device (90) via wireless communication.

As another example, some embodiments include a network connection method for connecting a network device and a terminal device, the network connection method comprising: deploying a routing device, and sending a first probe packet to the network device via the routing device to acquire an IP address of the network device; receiving, via the routing device, a first response packet generated by the network device based on the first probe packet, wherein the first response packet comprises the IP address of the network device; modifying, via the routing device, an IP address of the routing device based on the first response packet such that the IP address of the routing device and the IP address of the network device are in a same network segment; and assigning, via the routing device, an IP address in the same network segment as the IP address of the routing device to the terminal device.

In some embodiments, the network device comprises a first web server, and the network connection method further comprises: separately defining domain names of the network device and the routing device and separately sending out a correspondence between the IP address and domain name of the network device and a correspondence between the IP address and domain name of the routing device by the routing device; generating, by the terminal device, a webpage access request packet including an IP address of the web server to be accessed based on the domain name data of the web server to be accessed according to the received correspondences between the IP addresses and the domain names; and sending, by the terminal device, the webpage access request packet to the routing device; determining, via the routing device, whether the IP address of the web server to be accessed is the IP address of the network device or an IP address of the routing device; in response to determining that the IP address of the web server to be accessed is the IP address of the network device, forwarding a webpage access request packet to the first web server via the routing device; and sending a second response packet generated by the first web server in response to parsing the webpage access request packet to the terminal device via the routing device.

In some embodiments, the routing device comprises a second web server, and the network connection method further comprises: separately defining domain names of the network device and the routing device and then separately sending out a correspondence between the IP address and domain name of the network device and a correspondence between the IP address and domain name of the routing device in a form of signal via the routing device; generating, by the terminal device, a webpage access request packet including an IP address of the web server to be accessed based on the domain name data of the web server to be accessed according to the received correspondences between the IP addresses and the domain names; and sending, by the terminal device, the webpage access request packet to the routing device; determining, via the routing device, whether the IP address of the web server to be accessed is the IP address of the network device or an IP address of the routing device; and in response to determining that the IP address of the web server to be accessed is the IP address of the routing device, generating a third response packet by parsing the webpage access request packet by the second web server of the routing device, and sending the third response packet to the terminal device via the second communication module.

In some embodiments, the first probe packet and the first response packet are DCP packets.

### BRIEF DESCRIPTION OF THE DRAWINGS

The accompanying drawings are merely for schematic and illustrative description and demonstration of the present disclosure, instead of limiting the scope of the present disclosure.

FIG. 1 is a block diagram of an example routing device incorporating teachings of the present disclosure; and

FIG. 2 is a schematic flowchart of an example network connection method using the routing device illustrated in FIG. 1 and incorporating teachings of the present disclosure.

### REFERENCE NUMERALS AND DENOTATIONS THEREOF

100—Routing device
10—First communication module
20—Processing module
30—Second communication module
40—Second web server
80—Network device
81—First web server
90—Terminal device

### DETAILED DESCRIPTION

Various embodiments of the present disclosure include a routing device for accessing a network device by a terminal device. An example routing device includes a first communication module, a processing module, and a second communication module. The first communication module is configured to be communicably connected to the network device. The processing module is communicably connected to the first communication module and is capable of sending a first probe packet to the network device to acquire an IP address of the network device. The network device is capable of generating a first response packet based on the first probe packet and sending the first response packet to the first communication module. The first communication module is capable of sending the first response packet to the processing module. The processing module is capable of modifying an IP address of the routing device based on the first response packet such that the IP address of the routing device and the IP address of the network device are in a same network segment. The second communication module is communicably connected to the processing module and is configured to be communicably connected to the terminal device. The processing module is capable of assigning an IP address in the same network segment as the IP address of the routing device to the terminal device via the second communication module. The first response packet includes an IP address of the network device.

In some embodiments, the processing module is capable of automatically modifying IP address of the routing device based on the first response packet such that the IP address of the routing device and the IP address of the network device are in the same network segment. In this way, it is convenient for the user to establish a connection between the terminal device and the network device.

In some embodiments, the network device includes a first web server. The processing module separately defines domain names of the network device and the routing device and then separately sends out a correspondence between the IP address and domain name of the network device and a correspondence between the IP address and domain name of the routing device in a form of signal. The terminal device is capable of parsing out the IP address of the web server to be accessed based on the domain name data of the web server to be accessed according to the received correspondences between the IP addresses and the domain names, generating a webpage access request packet including the parsed IP address of the webserver to be accessed, and sending the webpage access request packet to the processing module via the second communication module. The processing module is capable of determining whether the IP address of the web server to be accessed is the IP address of the network device or the routing device based on the IP address of the web server to be accessed included in the webpage access request packet. In response to determining that the parsed out IP address is the IP address of the network device, the processing module is capable of forwarding the webpage access request packet to the first web server via the first communication module. The first web server is capable of generating a second response packet by parsing the webpage access request packet, and sending the second response packet to the processing module via the first communication module. The processing module is capable of sending the second response packet to the terminal device via the second communication module. In some embodiments, the routing device further includes a second web server. The second web server is configured to manage the routing device. The processing module separately defines domain names of the network device and the routing device and then separately sends out a correspondence between the IP address and domain name of the network device and a correspondence between the IP address and domain name of the routing device in a form of signal. The terminal device is capable of generating a webpage access request packet including an IP address of the web server to be accessed based on the domain name data of the web server to be accessed according to the received correspondences between the IP addresses and the domain names and sending the webpage access request packet to the processing module via the second communication module. The processing module is capable of determining whether the IP address of the web server to be accessed is the IP address of the network device or the routing device based on the IP address of the web server to be accessed included in the webpage access request packet. In response to determining that the parsed out IP address is the IP address of the routing device, the processing module is capable of forwarding the webpage access request packet to the second web server. The second web server is capable of generating a third response packet by parsing the webpage access request packet, and sending the third response packet to the terminal device via the second communication module. In this way, parameters of the routing device are configured.

In some embodiments, the first probe packet and the first response packet are Discovery and Configuration Protocol (DCP) packets.

In some embodiments, the processing module is capable of assigning, using Dynamic Host Configuration Protocol (DHCP), an IP address in the same network segment as the IP address of the routing device to the terminal device. The first communication module is capable of sending the first response packet to the processing module via a Media Access Control (MAC) layer. The second response packet is transmitted via the MAC layer. The third response packet is transmitted via a Transmission Control Protocol (TCP) layer.

In some embodiments, the first communication module is capable of being connected to the network device via wired communication. The second communication module is capable of being connected to the terminal device via wireless communication.

Some embodiments include a network connection method for connecting a network device and a terminal device. An example network connection method includes: deploying a routing device, and sending a first probe packet to the network device via the routing device to acquire an IP address of the network device; receiving, via the routing device, a a first response packet generated by the network device based on the first probe packet, wherein the first response packet includes the IP address of the network device; modifying, via the routing device, the IP address of the routing device based on the first response packet such that the IP address of the routing device and the IP address of the network device are in a same network segment; and assigning, via the routing device, an IP address in the same network segment as the IP address of routing device to the terminal device.

In some embodiments, the network device includes a first web server. The network connection method further includes: separately defining domain names of the network device and the routing device and then separately sending out a correspondence between the IP address and domain name of the network device and a correspondence that of the routing device, by the routing device, in a form of signal; parsing out the IP address of the web server to be accessed based on the domain name data of the web server to be accessed according to the received correspondences between the IP addresses and the domain names, and generating a webpage access request packet including the parsed IP address of the web server to be accessed, and sending the webpage access request packet to the routing device via the terminal device; determining, by the routing device, whether the IP address of the web server to be accessed is the IP address of the network device or an IP address of the routing device; in response to determining that the IP address of the web server to be accessed is the IP address of the network device, forwarding a webpage access request packet to the first web server via the routing device; and sending a second response packet generated by the first web server in response to parsing the webpage access request packet to the terminal device via the routing device.

In some embodiments, the routing device includes a second web server, and the network connection method further includes: separately defining domain names of the network device and the routing device and then separately sending out a correspondence between the IP address and domain name of the network device and a correspondence between the IP address and domain name of the routing device by the routing device in a form of signal; parsing out the IP address of the web server to be accessed based on the domain name data of the web server to be accessed according to the received correspondences between the IP addresses and the domain names, and generating a webpage access request packet including the parsed IP address of the web server to be accessed, and sending the webpage access request packet to the routing device via the terminal device; determining, via the routing device, whether the IP address of the web server to be accessed is the IP address of the network device or an IP address of the routing device; in response to determining that the IP address of the web server to be accessed is the IP address of the routing device, generating a third response packet by parsing the webpage access request packet by the second web server of the routing device, and sending the third response packet to the terminal device.

In some embodiments, the first probe packet and the first response packet are DCP packets.

For clearer descriptions of the technical features, objects, and the technical effects of the present disclosure, the specific embodiments of the present disclosure are hereinafter described with reference to the accompanying drawings. In the drawings, like reference numerals denote elements having the same structure or having the similar structure but the same function. In this text, the term “exemplary” or “schematic” is used herein to mean “serving as an example, instance, or illustration,” and any illustration or embodiment described herein as “exemplary” shall not be necessarily construed as preferred or advantageous over other illustrations or embodiments.

A routing device is a hardware device for accessing two or more networks and serves as a gateway between networks. A routing device is a dedicated smart network device that reads an address of each data packet and subsequently determines how to transmit the data packet. The routing device functions for connections to different networks and selection of channels for information transmission. Selecting a smooth and fast channel improves communication speed and smoothness of network systems, alleviates communication load of the network systems, and saves resources of the network systems, such that the network systems create more benefits.

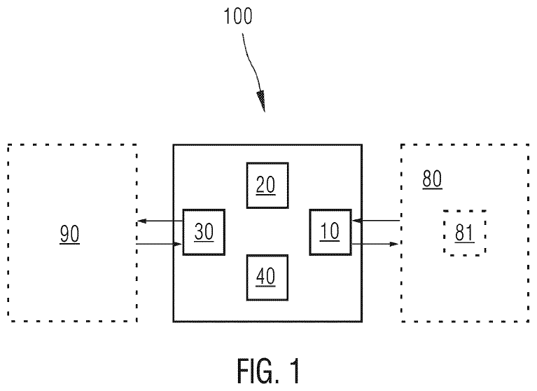

FIG. 1 is a schematic structural diagram of an example routing device incorporating teachings of the present disclosure. As illustrated in FIG. 1, the routing device 100 includes a first communication module 10, a processing module 20, and a second communication module 30.

The first communication module 10 is configured to be communicably connected to a network device 80. The processing module 20 is capable of sending a first probe packet to the network device 80 via the first communication module 10to acquire an IP address of the network device 80. The network device 80 is capable of generating a first response packet based on the first probe packet and sending the first response packet to the first communication module 10. The first probe packet and the first response packet are DCP packets. The first response packet includes an IP address of the network device 80, a subnet mask of the network device 80, and a gateway of the network device 80.

The processing module 20 is communicably connected to the first communication module 10. The first communication module 10 is capable of sending the first response packet generated by the network device 80 to the processing module 20. The processing module 20 is capable of modifying an IP address of the routing device based on the first response packet such that the IP address of the routing device and the IP address of the network device 80 are in a same network segment.

The second communication module 30 is communicably connected to the processing module 20 and is configured to be communicably connected to a terminal device 90. The processing module 20 is capable of assigning an IP address in the same network segment as the IP address of the routing device to the terminal device 90 via the second communication module 30.

In the routing device 100, the processing module 20 is capable of automatically modifying the IP address of the routing device based on the first response packet such that the IP address of the routing device and the IP address of the network device 80 are in the same network segment. In this way, it is convenient for the user to establish a connection between the terminal device 90 and the network device 80.

The network device 80 includes a first web server 81. The processing module 20 separately defines domain names of the network device 80 and the routing device 100 and then separately sends out a correspondence between the IP address and domain name of the network device 80 and a correspondence between the IP address and domain name of the routing device 100 in a form of signal. The terminal device 90 is capable of parsing out the IP address of the web server to be accessed based on the domain name data of the web server to be accessed according to the received correspondences between the IP addresses and the domain names, generating a webpage access request packet including the parsed IP address of the web server to be accessed, and sending the webpage access request packet to the processing module 20 via the second communication module 30.

The processing module 20 is capable of determining whether the IP address of the web server to be accessed is the IP address of the network device 80 or the routing device 100 based on the IP address of the web server to be accessed included in the webpage access request packet. In response to determining that the parsed out IP address is the IP address of the network device 80, the processing module 20 is capable of forwarding the webpage access request packet to the first web server 81 via the first communication module 10. The first web server 81 is capable of generating a second response packet by parsing the webpage access request packet and sending the second response packet to the processing module 20 via the first communication module 10. The processing module 20 is capable of sending the second response packet to the terminal device 90 via the second communication module 30.

In some embodiments, the routing device 100 further includes a second web server 40. The second web server 40 is configured to manage the routing device 100, for example, configuring a Wi-Fi name, a Wi-Fi password, a communication state, and selecting and switching channels, and checking the IP address and communication status of the connected network device 80. In response to determining that the IP address of the web server to be accessed is the IP address of the routing device by the processing module, a webpage access request packet is forwarded via the processing module to a second web server. A third response packet is generated by parsing the webpage access request packet by the second web server and sent to the terminal device via the second communication module. In this way, parameters of the routing device are configured.

In some embodiments, the processing module 20 is capable of assigning, using DHCP, an IP address in the same network segment as the IP address of the routing device to the terminal device 90. The first communication module 10 is capable of sending the first response packet to the processing module 20 via a MAC layer. The webpage access request packet and the second response packet are transmitted via the MAC layer. The third response packet is transmitted via a TCP layer.

In some embodiments, the first communication module 10 is an Ethernet interface card, and is capable of being connected to the network device 80 via wired communication. The second communication module 30 is a wireless network interface card and is capable of being connected to the terminal device 90 via wireless communication.

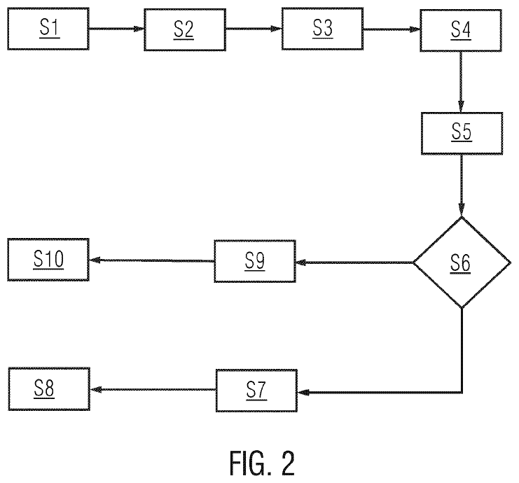

FIG. 2 is a schematic flowchart of an example network connection method using the routing device illustrated in FIG. 1 and incorporating teachings of the present disclosure. The method includes the following:

In S1, a routing device is deployed, and a first probe packet is sent to a network device via the routing device to acquire an IP address of the network device. In use, a first communication module, for example, an Ethernet interface card, of the routing device is connected to the network device with an RJ45 connector via a connector device, for example, a network cable. Upon power on, a processing module of the routing device, via a first communication module, sends a first probe packet, for example, a DCP packet, to the network device.

In S2, a first response packet generated by the network device based on the first probe packet is received via the routing device, wherein the first response packet includes the IP address of the network device. The network device receives the first probe packet and generates a first response packet by data processing. The first response packet includes an IP address, a subnet mask, and a gateway of the network device. The network device sends the first response packet to the first communication module. The first communication module sends the first response packet to the processing module via a MAC layer. The processing module defines a domain name of the network device and then sends out a correspondence between the IP address and the domain name of the network device via the second communication module in the form of, for example, Wi-Fi signals.

In S3, an IP address of the routing device is modified via the routing device based on the first response packet such that the IP address of the routing device and the IP address of the network device are in a same network segment. Upon processing, the processing module automatically modifies an IP address of the routing device such that the IP address of the routing device and the IP address of the network device are in a same network segment. The processing module defines a domain name of the routing device, and sends out the correspondence between the IP address and the domain name of the routing device via the second communication module in the form of, for example, Wi-Fi signals.

In S4, an IP address in the same network segment as the IP address of the routing device is assigned to the terminal device via the routing device. A user searches for a Wi-Fi name of the routing device using the communication module of the terminal device, for example, a Wi-Fi interface card, and establishes communication upon password authentication. The processing module assigns, using DHCP, an IP address in the same network segment as the IP address of the routing device to the terminal device.

The processing module automatically modifies, via the routing device, the IP address of the routing device such that the IP address of the routing device and the IP address of the network device are in the same network segment, and the IP address in the same network segment as the IP address of the routing device is assigned to the terminal device, such that a connection is established between the terminal device and the network device for subsequent access by the user.

In some embodiments, the network device includes a first web server. The network connection method further includes: In S5, the domain name data of the web server to be accessed is parsed out by the terminal device based on the received correspondences between the IP addresses and the domain names, and a webpage access request packet including the IP address of webpage access request packet is generated.

The user enters a domain name to access in a browser of the terminal device. The domain name data of the web server to be accessed is parsed out via the terminal device based on the received correspondence between the IP addresses and the domain names and a webpage access request packet including the IP address of webpage access request packet is generated and sent to the processing module via the second communication module.

In S6, whether the IP address of the web server to be accessed is the IP address of the network device or an IP address of the routing device is determined via the routing device.

In S7, in response to determining that the IP address of the web server to be accessed is the IP address of the network device, the webpage access request packet is forwarded to the first web server via the routing device.

In response to determining that the IP address of the web server to be accessed is the IP address of the network device, the processing module transparently transports the webpage access request packet to the first communication module via the MAC layer, and the webpage access request packet is sent to the first web server of the network device by the first communication module.

In S8, a second response packet generated by the first web server in response to parsing the webpage access request packet is sent to the terminal device via the routing device. Specifically:

The first web server of the network device generates a second response packet in response to parsing the webpage access request packet and sends the second response packet to the first communication module. The first communication module sends the second response packet to the processing module via the MAC layer. The processing module determines that a destination IP address indicates the terminal device and transmits the second response packet to the second communication module via the MAC layer. The second communication module transmits the second response packet to the terminal device, and the browser of the terminal device displays an access result.

Where parameters of the routing device need to be adjusted in the process of accessing the network device, the network connection method further includes:

In S9, in response to S6 which determining that the IP address of the web server to be accessed is the IP address of the routing device, a webpage access request packet is forwarded via the routing device to a second web server via the routing device.

In S10, a third response packet is generated by parsing the webpage access request packet by the second web server, and sent to the terminal device via the second communication module. Specifically:

The second web server parses the webpage access request packet to generate a third request packet, sends the third request packet to a second communication module via a TCP layer and then the second communication module sends the third request packet to the terminal device. The browser of the terminal device displays an access result. The second web server is configured to configure a Wi-Fi name, a Wi-Fi password, a communication state, and select and switch channels, and check the IP address and communication status of the connected network device. In this way, the user may configure parameters of the routing device.

Upon configuring the parameters of the routing device on the terminal device, the user may re-enter the domain name of the network device to access, and access the network device through steps S5, S6, S7, and S8.

In some embodiments, the first probe packet and the first response packet are DCP packets.

It should be understood that, although this specification is described based on the example embodiments, not each of the embodiments discloses an independent technical solution. Such description is only for clarity. A person skilled in the art should consider the specification as an entirety. The technical solutions of particular embodiments may also be suitably combined to derive other embodiments that may be understood by a person skilled in the art.

A series of detailed descriptions given in this specification are merely intended to illustrate feasible embodiments of the present disclosure, instead of limiting the protection scope of the present disclosure. Any equivalent embodiments or modifications, for example, combinations, segmentations, or repetition of features, derived without departing from the spirit of the present disclosure shall fall within the protection scope of the present disclosure.

What is claimed is:

1. A routing device for accessing a network device by a terminal device, the device comprising:
a first communication module to connect to the network device;
a processing module connected to the first communication module,
wherein the processing module sends a first probe packet to the first communication module sends the first communication module sends the first probe packet to the network device to acquire an IP address of the network device, the network device generates a first response packet based on the first probe packet and sends the first response packet to the first communication module, the first communication module sends the first response packet to the processing module, and the processing module an IP address of the routing device based on the first response packet so the IP address of the routing device and the IP address of the network device are in a shared network segment, the first response packet comprising an IP address of the network device; and
a second communication module connected to the processing module and the terminal device, wherein the processing module assigns an IP address in the shared network segment to the terminal device via the second communication module.

2. The routing device according to claim 1, wherein:
the network device comprises a first web server; and
the processing module separately defines domain names of the network device and the routing device and then separately sends out a correspondence between the IP address and domain name of the network device and a correspondence between the IP address and domain name of the routing device in a form of signal;
the terminal device parses out the IP address of the web server to be accessed based on the domain name data of the web server to be accessed according to the received correspondences between the IP addresses and the domain names, generates a webpage access request packet including the parsed IP address of the web server to be accessed, and sends the webpage access request packet to the processing module via the second communication module; and
the processing module determines whether the IP address of the web server to be accessed is the IP address of the network device 49-or the routing device based on the IP address of the web server to be accessed included in the webpage access request packet;
in response to determining that the parsed out IP address is the IP address of the network device, the processing module forwards the webpage access request packet to the first web server via the first communication module;
the first web server generates a second response packet by parsing the webpage access request packet, and sends the second response packet to the processing module via the first communication module; and
the processing module sends the second response packet to the terminal device via the second communication module.

3. The routing device according to claim 1, further comprising a second web server to manage the routing device;
wherein the processing module separately defines domain names of the network device and the routing device and then separately sends out a correspondence between the IP address and domain name of the network device and a correspondence between the IP address and domain name of the routing device in a form of signal;
the terminal device generates a webpage access request packet including an IP address of the web server to be accessed based on the domain name data of the web server to be accessed according to the received correspondences between the IP addresses and the domain names, and sends the webpage access request packet to the processing module via the second communication module;
the processing module determines whether the IP address of the web server to be accessed is the IP address of the network device or the routing device based on the IP address of the web server to be accessed included in the webpage access request packet;
in response to determining that the parsed out IP address is the IP address of the routing device, the processing module forwards the webpage access request packet to the second web server; and
the second web server generates a third response packet by parsing the webpage access request packet, and sends the third response packet to the terminal device via the second communication module.

4. The routing device according to claim 1, wherein the first probe packet and the first response packet comprises DCP packets.

5. The routing device according to claim 2, wherein;
the processing module assigns, using DHCP, the IP address in the same network segment as the IP address of the routing device to the terminal device;
the first communication module sends the first response packet to the processing module via an MAC layer; and
the webpage access request packet and the second response packet are transmitted via the MAC layer.

6. The routing device according to claim 3, wherein the third response packet is transmitted via a TCP layer.

7. The routing device according to claim 1, wherein:
the first communication module connects to the network device through wired communication; and
the second communication module connects to the terminal device through wireless communication.

8. A network connection method for connecting a network device and a terminal device, the method comprising:
deploying a routing device, and sending a first probe packet to the network device via the routing device to acquire an IP address of the network device;
receiving, via the routing device, a first response packet generated by the network device based on the first probe packet, wherein the first response packet comprises the IP address of the network device;
modifying, via the routing device, an IP address of the routing device based on the first response packet such that the IP address of the routing device and the IP address of the network device are in a shared network segment; and
assigning, via the routing device, an IP address in the same network segment as the IP address of the routing device to the terminal device.

9. The network connection method according to claim 8, wherein the network device comprises a first web server, and the network connection method further comprises:
separately defining domain names of the network device and the routing device and separately sending out a correspondence between the IP address and domain name of the network device and a correspondence between the IP address and domain name of the routing device by the routing device; generating, by the terminal device, a webpage access request packet including an IP address of the web server to be accessed based on the domain name data of the web server to be accessed according to the received correspondences between the IP addresses and the domain names;
and sending, by the terminal device, the webpage access request packet to the routing device;
determining, via the routing device, whether the IP address of the web server to be accessed is the IP address of the network device or an IP address of the routing device;
in response to determining that the IP address of the web server to be accessed is the IP address of the network device, forwarding a webpage access request packet to the first web server via the routing device; and
sending a second response packet generated by the first web server in response to parsing the webpage access request packet to the terminal device via the routing device.

10. The network connection method according to claim 8, wherein the routing device comprises a second web server, and the network connection method further comprises:
separately defining domain names of the network device and the routing device and then separately sending out correspondence between the IP address and domain name of the network device and a correspondence between the IP address and domain name of the routing device in a form of signal via the routing device; generating, by the terminal device, a webpage access request packet including an IP address of the web server to be accessed based on the domain name data of the web server to be accessed according to the received correspondences between the IP addresses and the domain names; and sending, by the terminal device, the webpage access request packet to the routing device;
determining, via the routing device, whether the IP address of the web server to be accessed is the IP address of the network device or an IP address of the routing device;
in response to determining that the IP address of the web server to be accessed is the IP address of the routing device, generating a third response packet by parsing the webpage access request packet by the second web server of the routing device, and sending the third response packet to the terminal device via the second communication module.

11. The network connection method according to claim 8, wherein the first probe packet and the first response packet comprise DCP packets.
